(19) United States
(12) Patent Application Publication
(10) Pub. No.: US 2026/0212029 A1
(43) Pub. Date: Jul. 23, 2026

(54) STORAGE SYSTEM AND DATA PROCESSING METHOD

(71) Applicant: Hitachi Vantara, Ltd., Yokohama-shi (JP)

(72) Inventors: Norio SHIMOZONO, Tokyo (JP); Mitsuo HAYASAKA, Tokyo (JP)

(73) Assignee: Hitachi Vantara, Ltd., Yokohama-shi (JP)

(21) Appl. No.: 19/314,309

(22) Filed: Aug. 29, 2025

(30) Foreign Application Priority Data
Jan. 21, 2025 (JP) 2025-008728

(51) Int. Cl. G06F 21/60

(52) U.S. Cl. CPC G06F 21/602

(57) ABSTRACT

When a plurality of pieces of encrypted data of the same content encrypted with the same encryption key are present in a pool volume, a storage system executes deduplication by leaving any of the encrypted data and releasing other encrypted data and associating an address of a virtual volume corresponding to the released encrypted data with the remaining encrypted data, and when unencrypted data having same content as the encrypted data is present in the pool volume, the storage system executes deduplication by releasing the encrypted data while leaving the unencrypted data, and associating an address of a virtual volume corresponding to the released encrypted data with the unencrypted data.

### BACKGROUND OF THE INVENTION

### 1. Field of the Invention

The present invention relates to a storage system and a data processing method.

### 2. Description of Related Art

In the related art, there is a technique described in US-B1-008117464 (Patent Literature 1) in order to achieve deduplication of encrypted data. This publication discloses that “A network storage server receives write requests from clients via a network and internally buffers data blocks written by the write requests. At a consistency point, the storage server commits the data blocks to nonvolatile mass storage. In the consistency point process, a storage operating system in the network storage server compresses the data blocks, encrypts selected data blocks, and stores the compressed and (possibly) encrypted data blocks in the nonvolatile mass storage facility. Data blocks can also be fingerprinted in parallel with compression and/or encryption, to facilitate deduplication. Data blocks can be indexed and classified according to content or attributes of the data. Encryption can be applied at different levels of logical container granularity, where a separate, unique cryptographic key is used for each encrypted data container. To facilitate deduplication, the system creates an additional, shared encryption key for each data block duplicated between two or more logical containers.”

### CITATION LIST

### Patent Literature

PTL 1: US-B1-008117464

### SUMMARY OF THE INVENTION

In the related art, since a key is generated for each file, it is necessary to manage a large number of keys in the entire system. Therefore, performance is deteriorated and a capacity is compressed. In addition, when deleting data, it is necessary to reliably delete a large amount of encryption keys, which requires hardware cost and time.

Therefore, an object of the present invention is to reduce the number of keys that need to be managed and to achieve both encryption and deduplication while suppressing performance degradation.

In order to solve the above problems, one representative storage system of the present invention is a storage system including: a storage device; and a processor configured to process data input to and output from the storage device, in which the processor manages a correspondence relationship between an address in a pool volume constructed in a storage area of the storage device and an address in a virtual volume provided to an outside by a logical-to-physical translation table, encrypts data with an encryption key and is configured to store the data in the pool volume as encrypted data, and when unencrypted data having same content as the encrypted data is present in the pool volume, executes deduplication by releasing the encrypted data while leaving the unencrypted data, and associating an address of a virtual volume corresponding to the released encrypted data with the unencrypted data.

Further, one representative data management method of the present invention is a data management method in a storage system including a storage device, and a processor configured to process data input to and output from the storage device, the data management method including: by the processor, managing a correspondence relationship between an address in a pool volume constructed in a storage area of the storage device and an address in a virtual volume provided to an outside by a logical-to-physical translation table; encrypting data with an encryption key and storing the data in the pool volume as encrypted data; and a step of, when unencrypted data having same content as the encrypted data is present in the pool volume, the processor executing deduplication by releasing the encrypted data while leaving the unencrypted data, and associating an address of a virtual volume corresponding to the released encrypted data with the unencrypted data.

According to the present invention, the number of keys that need to be managed in the storage system can be reduced, and both the encryption and the deduplication can be achieved while suppressing performance degradation. Problems, configurations, and effects other than those described above will become apparent by the following description of an embodiment.

### BRIEF DESCRIPTION OF THE DRAWINGS

FIG. 1 is a conceptual diagram of an entire system;

FIG. 2 is a hardware structure diagram of a storage system;

FIG. 3 is an illustrative diagram of a configuration example of a memory;

FIG. 4 illustrates a specific example of a volume management table;

FIG. 5 illustrates a specific example of a logical-to-physical translation table;

FIG. 6 illustrates a specific example of a page management table;

FIG. 7 illustrates a specific example of an encryption key management table;

FIG. 8 is a flowchart illustrating a processing procedure of virtual volume creation processing;

FIG. 9 is a flowchart illustrating a processing procedure of virtual volume write processing;

FIG. 10 is a flowchart illustrating a processing procedure of deduplication processing;

FIG. 11 is a flowchart illustrating a processing procedure of open data deduplication information acquisition processing;

FIG. 12 is a flowchart illustrating a processing procedure of virtual volume read processing; and

FIG. 13 is a flowchart illustrating a processing procedure of virtual volume deletion processing.

### DESCRIPTION OF EMBODIMENTS

In the following description, an “interface unit” may be one or more interfaces. The one or more interfaces may be one or more communication interface devices of the same type (for example, one or more network interface cards (NICs)) or two or more communication interface devices of different types (for example, a NIC and a host bus adapter (HBA)).

In the following description, a “memory unit” is one or more memories, and may typically be a main storage device. At least one memory in the memory unit may be a volatile memory or a nonvolatile memory.

In the following description, a “PDEV unit” is one or more PDEVs, and may typically be an auxiliary storage device. The “PDEV” means a physical storage device, and is typically a non-volatile storage device, for example, a hard disk drive (HDD) or a solid state drive (SSD).

In the following description, a “storage unit” is at least one of the memory unit and the PDEV unit (typically, at least the memory unit).

In the following description, a “processor unit” is one or more processors. At least one of the processors may typically be a micro-processor such as a central processing unit (CPU), and may be another type of processor such as a graphics processing unit (GPU). The at least one processor may be a single core processor or a multi-core processor.

In addition, the at least one processor may be a processor in a broad sense such as a hardware circuit (for example, a field-programmable gate array (FPGA) or an application specific integrated circuit (ASIC)) that performs a part or all of the processing.

In the following description, information from which an output is obtained with respect to an input may be described by an expression such as “xxx table”, but the information may be data of any structure or may be a training model such as a neural network that generates an output with respect to an input. Therefore, the “xxx table” can be referred to as “xxx information”.

In the following description, a configuration of each table is an example. One table may be divided into two or more tables, or all or some of the two or more tables may be one table.

In the following description, processing may be described using a “program” as a subject, but since a program is executed by a processor unit to perform predetermined processing using a storage unit and/or an interface unit as appropriate, the subject of the processing may be the processor unit (or a device such as a controller including the processor unit).

The program may be installed in a device such as a computer, or may be, for example, a program distribution server or a computer-readable (for example, non-transitory) recording medium.

Further, in the following description, two or more programs may be implemented as one program, or one program may be implemented as two or more programs.

In the following description, a “computer system” is a system including one or more physical computers. The physical computer may be a general-purpose computer or a dedicated computer. The physical computer may function as a computer (for example, a host computer) that issues an input/output (I/O) request, or may function as a computer (for example, a storage device) that performs I/O of data in response to the I/O request.

That is, the computer system may be at least one of a host system that is one or more host computers that issue an I/O request and a storage system that is one or more storage devices that perform I/O of data in response to the I/O request. One or more virtual computers (for example, virtual machines (VMs)) may be executed in the at least one physical computer. The virtual computer may be a computer that issues an I/O request or a computer that performs I/O of data in response to the I/O request.

The computer system may be a distributed system including one or more (typically, a plurality of) physical node devices. The physical node device is a physical computer.

A physical computer (for example, the node device) may execute predetermined software to construct software-defined anything (SDx) in the physical computer or the computer system including the physical computer. As SDx, for example, a software defined storage (SDS) or a software-defined data center (SDDC) may be adopted.

For example, the storage system as an SDS may be constructed by executing software having a storage function on a physical general-purpose computer.

In addition, at least one physical computer (for example, a storage device) may execute one or more virtual computers as the host system and a virtual computer as a storage controller of the storage system (typically, a device that inputs and outputs data to and from the PDEV unit in response to an I/O request).

In other words, the at least one physical computer may have both a function as at least a part of the host system and a function as at least a part of the storage system.

The computer system (typically, the storage system) may include a redundant configuration group. The redundant configuration may be implemented in a plurality of node devices through erasure coding, a redundant array of independent nodes (RAIN), and inter-node mirroring, and the like, or may be implemented in a single computer (for example, a node device) through one or more redundant array of independent (or inexpensive) disks (RAID) groups as at least a part of the PDEV unit.

In addition, in the following description, a “data set” is a block of logical electronic data viewed from a program such as an application program, and may be, for example, any of a record, a file, a key-value pair, and a tuple.

In the following description, an identification number is used as identification information of various targets, but identification information of a type other than the identification number (for example, an identifier including an alphabetic character or a code) may be adopted.

In addition, in the following description, when elements of the same type are described without being distinguished, a reference numeral (or a common numeral of the reference numerals) may be used, and when elements of the same type are distinguished and described, identification numerals (or the reference numerals) of the elements may be used.

For example, in a case where a “page”, which is a unit of a storage area, is described without being particularly distinguished, the “page” may be described as “page 312”, and in a case where individual pages are distinguished and described, the “page” may be described as “page #0” or “page #1” using the page number, or may be described as “page 312-0” or “page 312-1” using a reference code.

### Embodiment 1

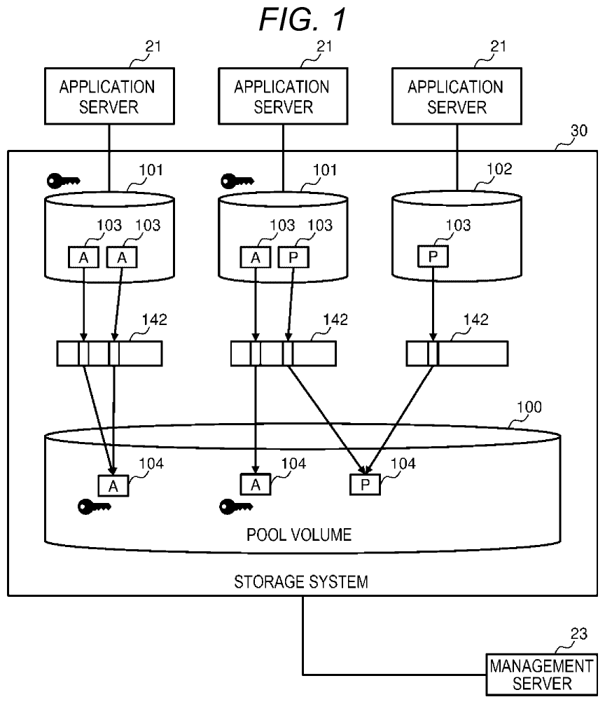

Hereinafter, Embodiment 1 of the invention will be described with reference to FIGS. 1 to 13.

FIG. 1 is a conceptual diagram of an entire system. A storage system 30 is connected to application servers 21 and a management server 23. The storage system 30 includes a pool volume 100 constructed using a storage area of the PDEV unit. The storage system 30 provides a virtual volume as an access destination from the external application servers 21. The virtual volume includes encrypted virtual volumes 101 in which data is encrypted and stored, and an unencrypted virtual volume 102 in which data is stored without being encrypted.

The storage system 30 generates an encryption key for each user and allocates the encrypted virtual volume 101 to each user. That is, one encrypted virtual volume 101 is used by one user. Incidentally, although it is possible to allocate a plurality of encrypted virtual volumes 101 to one user, in the present embodiment, one encrypted virtual volume 101 is allocated to one user to simplify the description. Therefore, different users use different encrypted virtual volumes 101.

The unencrypted virtual volume 102 is used to input and output open data that does not need to be encrypted. A user who handles the open data accesses the unencrypted virtual volume 102. A plurality of users may access one unencrypted virtual volume 102. Further, the open data having a high reference frequency may be automatically collected and stored in the unencrypted virtual volume 102.

The storage system 30 manages a correspondence relationship between a logical page 103 of the virtual volume and a physical page 104 of the pool volume 100 in a logical-to-physical translation table 142. Further, the storage system 30 executes deduplication in the pool volume 100.

Specifically, when a plurality of pieces of encrypted data of the same content encrypted with the same encryption key are present in the pool volume 100, the storage system 30 executes deduplication by leaving any encrypted data and releasing other encrypted data, and associating an address of the virtual volume corresponding to the released encrypted data with the remaining encrypted data. In the example of FIG. 1, two logical pages 103 whose contents are “A” are present in one encrypted virtual volume 101. The two logical pages 103 are associated with the same encrypted physical page 104 by the logical-to-physical translation table 142.

On the other hand, when a plurality of pieces of encrypted data of the same content encrypted with different encryption keys are present in the pool volume 100, the storage system 30 does not execute the deduplication. In the example of FIG. 1, the logical pages 103 whose content is “A” are present in the two encrypted virtual volumes 101, respectively. The two logical pages 103 are associated with individual encrypted physical pages 104 by the logical-to-physical translation table 142.

When unencrypted data having the same content as the encrypted data is present in the pool volume 100, the storage system 30 executes deduplication by releasing the encrypted data while leaving the unencrypted data, and associating an address of the virtual volume corresponding to the released encrypted data with the unencrypted data. In the example of FIG. 1, the logical pages 103 whose content is “P” are present in the encrypted virtual volume 101 and the unencrypted virtual volume 102, respectively. The two logical pages 103 are associated with the same unencrypted physical page 104 by the logical-to-physical translation table 142.

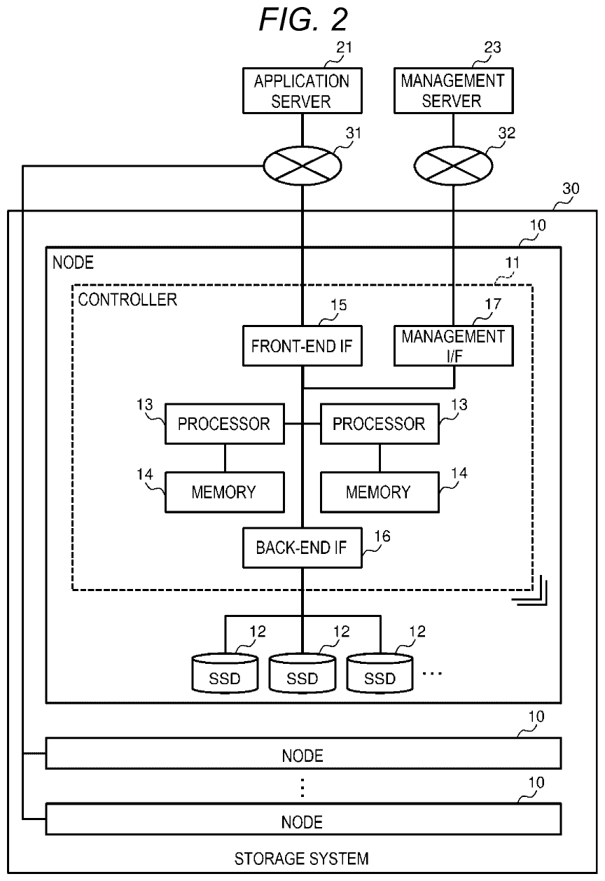

FIG. 2 is a hardware structure diagram of the storage system. The storage system 30 includes a plurality of nodes 10. The node 10 includes one or more SSDs 12, which are PDEV units, and a controller 11.

The controller 11 includes processors 13, a front-end interface 15, a back-end interface 16, and a management interface 17. The front-end interface 15, the back-end interface 16, and the management interface 17 are examples of an interface unit.

The front-end interface 15 is a communication interface device that mediates data exchange between the application server 21 and the controller 11. The application server 21 is connected to the front-end interface 15 via a network 31. The application server 21 transmits an I/O request (write request or read request) designating the address of the virtual volume.

The management interface 17 is a communication interface device that mediates data exchange between the management server 23 and the controller 11. The management server 23 is connected to the management interface 17 via a network 32. The network 31 and the network 32 may be the same communication network. The management server 23 manages the storage system 30.

The back-end interface 16 is a communication interface device that mediates data exchange between the plurality of SSDs 12 and the controller 11.

A memory 14 stores a program executed by the processor 13, data used by the processor 13, and the like. The processor 13 executes the program stored in the memory 14. In the present embodiment, for example, a set of the memory 14 and the processor 13 is duplicated.

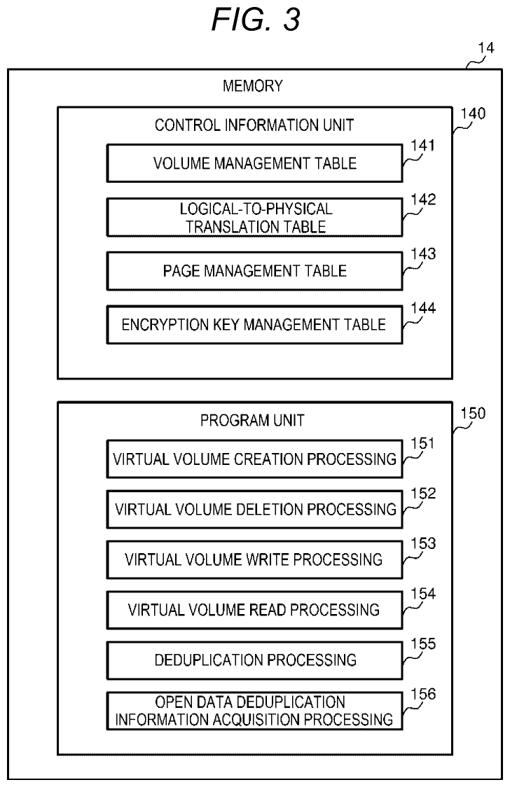

FIG. 3 is an illustrative diagram of a configuration example of the memory. The memory 14 includes a control information unit 140 and a program unit 150. The control information unit 140 stores a volume management table 141, the logical-to-physical translation table 142, a page management table 143, and an encryption key management table 144. The program unit 150 stores virtual volume creation processing 151, virtual volume deletion processing 152, virtual volume write processing 153, virtual volume read processing 154, deduplication processing 155, and open data deduplication information acquisition processing 156.

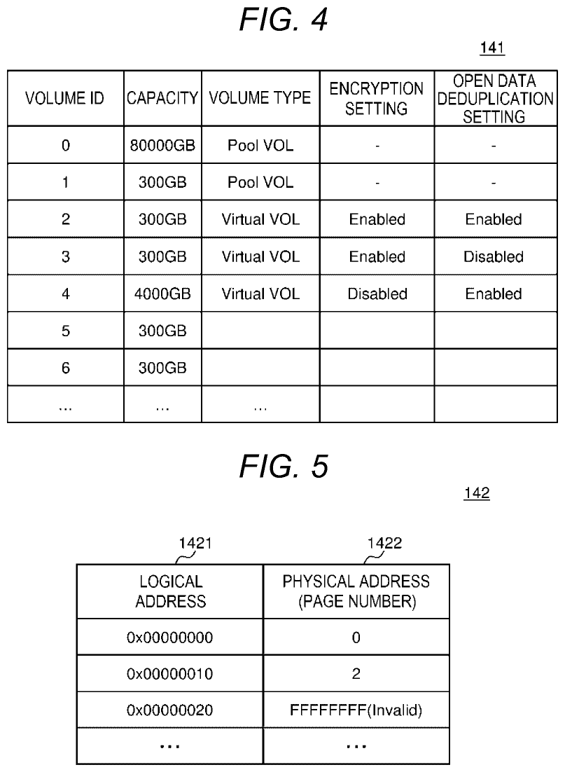

FIG. 4 is a specific example of the volume management table 141. The volume management table 141 is data in which a capacity, a volume type, an encryption setting, and an open data deduplication setting are associated with a volume ID.

The volume ID is identification information for uniquely identifying a volume. The capacity indicates the capacity of the volume. The volume type takes a value of either “Pool VOL” or “Virtual VOL”.

The encryption setting takes a value of “Enabled” or “Disabled” when the volume type is “Virtual VOL”. The encryption setting “Enabled” indicates that the virtual volume is an encrypted virtual volume. The encryption setting “Disabled” indicates that the virtual volume is an unencrypted virtual volume.

The open data deduplication setting takes a value of “Enabled” or “Disabled” when the volume type is “Virtual VOL” and the encryption setting is “Enabled”. The open data deduplication setting “Enabled” indicates that the deduplication is executed when the encrypted data and the unencrypted data overlap. The open data deduplication setting “Disabled” indicates that the deduplication is not executed when the encrypted data and the unencrypted data overlap. That is, by setting the open data deduplication setting to “Disabled”, the user can store write data in the encrypted virtual volume as the encrypted data regardless of whether the write data overlaps the open data.

FIG. 5 is a specific example of the logical-to-physical translation table 142. The logical-to-physical translation table 142 is data in which a physical address 1422 is associated with a logical address 1421. The logical address 1421 is an address in the virtual volume. The application server 21 reads and writes data by designating the logical address 1421. The physical address 1422 is an address in the pool volume and corresponds to a page number of a physical page. Data to be read or written is stored in an area indicated by the physical address 1422.

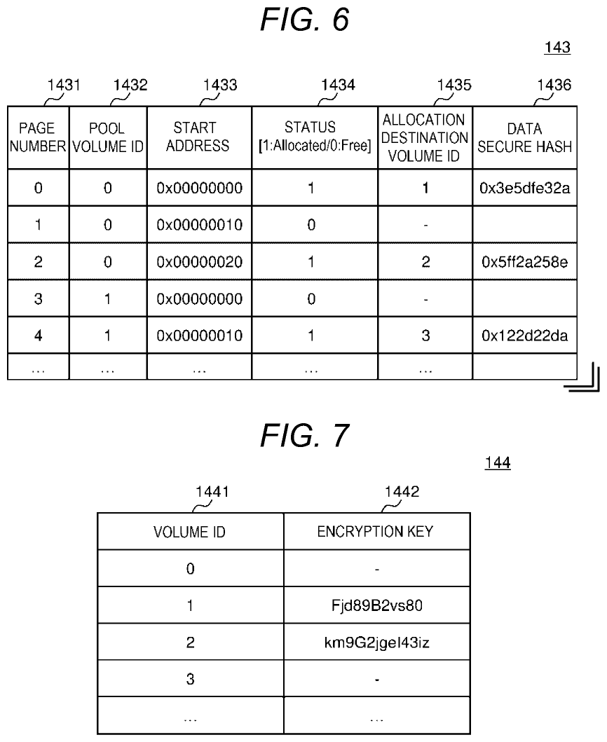

FIG. 6 illustrates a specific example of the page management table 143. The page management table 143 is a table in which a pool volume ID 1432, a start address 1433, a status 1434, an allocation destination volume ID 1435, and a data secure hash 1436 are associated with a page number 1431.

The page number 1431 is identification information for uniquely identifying a physical page. The pool volume ID 1432 indicates a pool volume in which the physical page is present. The start address 1433 indicates from which address of the pool volume the physical page starts. The status 1434 takes a value of “1: Allocated” or “0: Free”. The allocation destination volume ID 1435 indicates a virtual volume to which the physical page is allocated. The data secure hash 1436 indicates a hash value calculated from data in the physical page.

FIG. 7 illustrates a specific example of the encryption key management table 144. The encryption key management table 144 is a table in which an encryption key 1442 is associated with the volume ID 1441. The volume ID 1441 is identification information for uniquely identifying a volume. The encryption key is generated for each user and associated with the encrypted virtual volume.

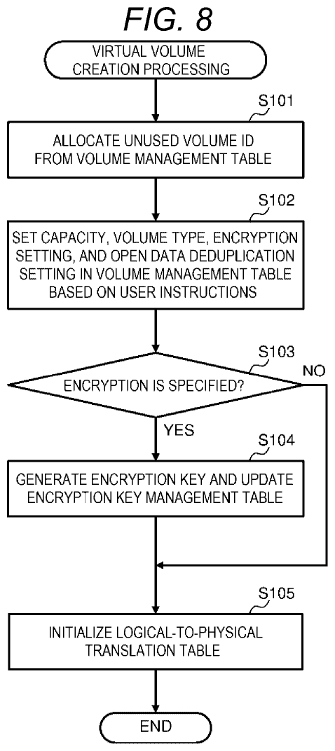

FIG. 8 is a flowchart illustrating a processing procedure of the virtual volume creation processing 151. When the processor 13 reads and executes the virtual volume creation processing 151 of the memory 14, the following steps S101 to S105 are sequentially executed.

In step S101, the processor 13 allocates an unused volume ID from the volume management table 141 to a new virtual volume. Thereafter, the processing proceeds to step S102.

In step S102, the processor 13 sets the capacity, the volume type, the encryption setting, and the open data deduplication setting in the volume management table 141 based on user instructions. Thereafter, the processing proceeds to step S103.

In step S103, the processor 13 determines whether the encryption is specified. If the encryption is specified (step S103: YES), the processing proceeds to step S104. If the encryption is not specified (step S104: NO), the processing proceeds to step S105.

In step S104, the processor 13 generates an encryption key and updates the encryption key management table 144. Thereafter, the processing proceeds to step S105.

In step S105, the processor 13 initializes the logical-to-physical translation table 142 and ends the processing.

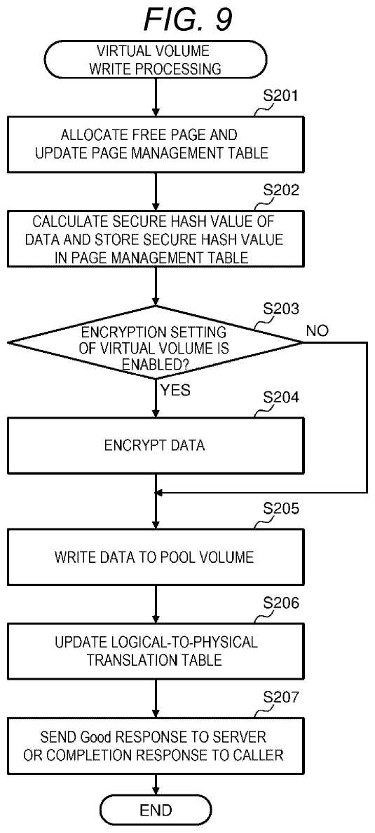

FIG. 9 is a flowchart illustrating a processing procedure of the virtual volume write processing 153. When the processor 13 reads and executes the virtual volume write processing 153 of the memory 14, the following steps S201 to S207 are sequentially executed.

In step S201, the processor 13 allocates an empty page to the write data and updates the page management table 143. Thereafter, the processing proceeds to step S202.

In step S202, the processor 13 calculates a secure hash value of the data to be written, and stores the secure hash value in the page management table 143. Thereafter, the processing proceeds to step S203.

In step S203, the processor 13 refers to the volume management table 141 and determines whether the encryption setting of the virtual volume is enabled. If enabled (step S203: YES), the processing proceeds to step S204. If disabled (step S203: NO), the processing proceeds to step S205.

In step S204, the processor 13 encrypts the write data. Thereafter, the processing proceeds to step S205.

In step S205, the processor 13 writes the write data to the pool volume. Thereafter, the processing proceeds to step S206.

In step S206, the processor 13 updates the logical-to-physical translation table 142. Thereafter, the processing proceeds to step S207.

In step S207, the processor 13 sends a Good response to a server or a completion response to a caller, and ends the processing.

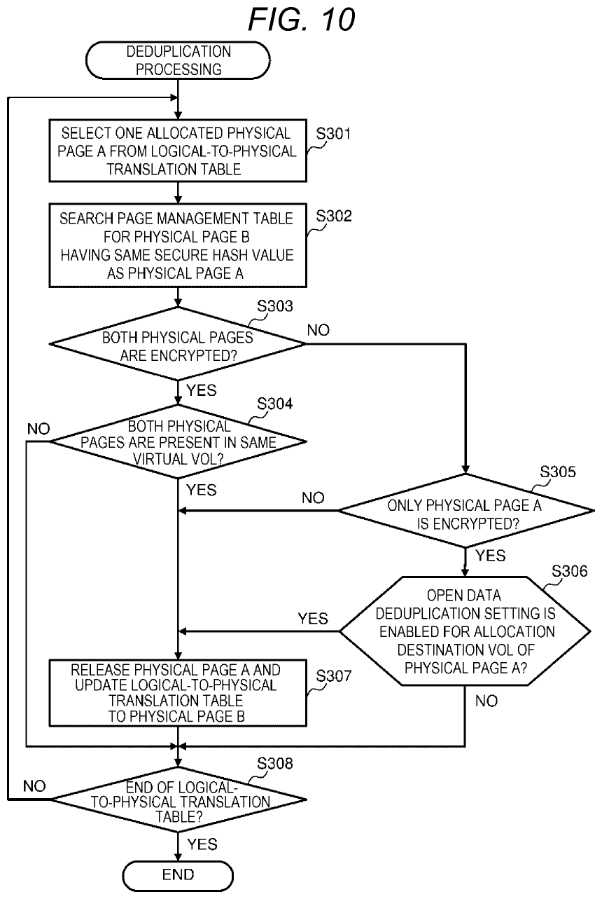

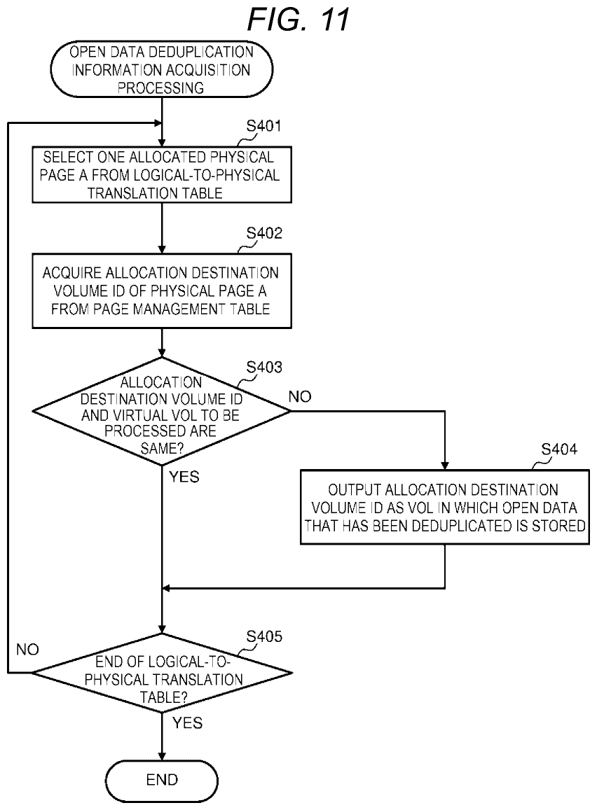

FIG. 10 is a flowchart illustrating a processing procedure of the deduplication processing 155. When the processor 13 reads and executes the deduplication processing 155 of the memory 14, the following steps S301 to S308 are sequentially executed. The processor 13 periodically executes the deduplication processing 155 at predetermined time intervals.

In step S301, the processor 13 selects one allocated physical page A from the logical-to-physical translation table 142. Thereafter, the processing proceeds to step S302.

In step S302, the processor 13 searches the page management table 143 for a physical page B having the same secure hash value as the physical page A. Thereafter, the processing proceeds to step S303.

In step S303, the processor 13 determines whether both the physical page A and the physical page B are encrypted. If both of the physical pages are encrypted (step S303: YES), the processing proceeds to step S304. If at least one of the physical pages is not encrypted (step S303: NO), the processing proceeds to step S305.

In step S304, the processor 13 determines whether both the physical page A and the physical page B are present in the same virtual volume. If both of the physical pages are present in the same virtual volume (step S304: YES), the processing proceeds to step S307. If the physical page A and the physical page B are present in different virtual volumes (step S304: NO), the processing proceeds to step S308.

In step S305. the processor 13 determines whether only the physical page A is encrypted. If only the physical page A is encrypted (step S305: YES), the processing proceeds to step S306. If the physical page A is not encrypted (step S305: NO), the processing proceeds to step S307.

In step S306, the processor 13 determines whether the open data deduplication setting is enabled for an allocation destination volume of the physical page A. If enabled (step S306: YES), the processing proceeds to step S307. If disabled (step S306: NO), the processing proceeds to step S308.

In step S307, the processor 13 releases the physical page A and updates a corresponding portion of the logical-to-physical translation table 142 to the physical page B. Thereafter, the processing proceeds to step S308.

In step S308, the processor 13 determines whether the end of the logical-to-physical translation table 142 has been reached. If the end of the logical-to-physical translation table 142 has not been reached (step S308: NO), the processing returns to step S301. If the end of the logical-to-physical translation table 142 has been reached (step S308: YES), the deduplication processing is ended.

In the process illustrated in FIG. 10, if the physical page A is not encrypted (step S305: NO), the processing proceeds to step S307, and the physical page A is released. Alternatively, if the physical page A is not encrypted, the processing may be branched depending on whether the physical page B is encrypted. In this case, if neither the physical page A nor the physical page B is encrypted, the processing proceeds to step S307 to release the physical page A, and if only the physical page B is encrypted, the processing proceeds to step S308 and does not execute the deduplication. Therefore, the deduplication of the unencrypted physical page A and the encrypted physical page B is executed when this processing loops and the physical page B is selected in step S301.

FIG. 11 is a flowchart illustrating a processing procedure of the open data deduplication information acquisition processing 156. When the processor 13 reads and executes the virtual volume write processing 153 of the memory 14, the following steps S401 to S405 are sequentially executed. When receiving a request from the user, the processor 13 executes the open data deduplication information acquisition processing 156.

In step S401, the processor 13 selects one allocated physical page A from the logical-to-physical translation table 142. Thereafter, the processing proceeds to step S402.

In step S402, the processor 13 acquires an allocation destination volume ID of the physical page A from the page management table 143. Thereafter, the processing proceeds to step S403.

In the step S403, the processor 13 determines whether the allocation destination volume ID and the virtual volume to be processed are the same. If the destination volume ID and the virtual volume to be processed are not the same (step S403: NO), the processing proceeds to step S405. If the allocation destination volume ID and the virtual volume to be processed are the same (step S403: YES), the processing proceeds to step S404.

In step S404, the processor 13 outputs the allocation destination volume ID as a volume in which the open data that has been deduplicated is stored. Thereafter, the processing proceeds to step S405.

In step S405, the processor 13 determines whether the end of the logical-to-physical translation table 142 has been reached. If the end of the logical-to-physical translation table 142 has not been reached (step S405: NO), the processing returns to step S401. If the end of the logical-to-physical translation table 142 has been reached (step S405: YES), the deduplication processing is ended.

In the processing illustrated in FIG. 11, the address of the encrypted virtual volume assigned to the user is sequentially set as a processing target, and processing of outputting the location of the open data for the encrypted data that has been deduplicated with the open data is repeated. As a result, a list of information related to the encrypted data that has been deduplicated with the open data (an actual location of the data) is output.

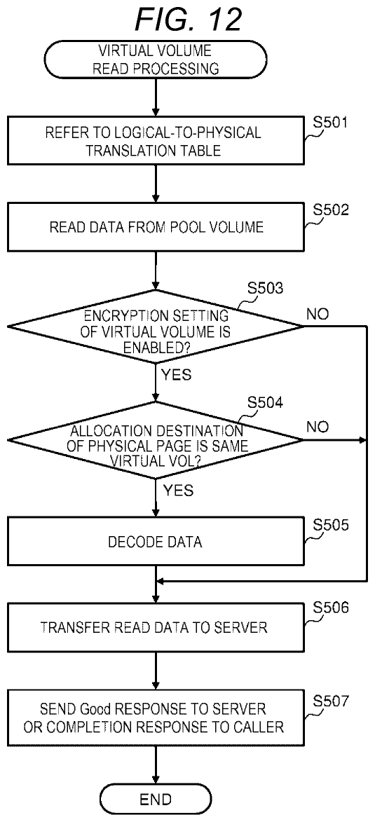

FIG. 12 is a flowchart illustrating an example of a processing procedure of the virtual volume read processing 154. When the processor 13 reads and executes the virtual volume read processing 154 of the memory 14, the following steps S501 to S507 are sequentially executed.

In step S501, the processor 13 refers to the logical-to-physical translation table 142 and specifies a physical address based on a logical address designated by the read. Thereafter, the processing proceeds to step S502.

In step S502, the processor 13 reads data from the pool volume 100. Thereafter, the processing proceeds to step S503.

In step S503, the processor 13 refers to the volume management table 141 and determines whether the encryption setting of the virtual volume is enabled. If enabled (step S503: YES), the processing proceeds to step S504. If disabled (step S503: NO), the processing proceeds to step S506.

In step S504, the processor 13 determines whether an allocation destination of the physical page is the same virtual volume. If the allocation destination of the physical page is the same virtual volume (step S504: YES), the processing proceeds to step S505. If the allocation destination of the physical page is not the same virtual volume (step S504: NO), the processing proceeds to step S506. The case where the allocation destination of the physical page is not the same virtual volume is a state in which a physical page of a read destination is unencrypted data due to the deduplication between the encrypted data and the unencrypted data.

In step S505, the processor 13 decodes the data read from the pool volume 100. Thereafter, the processing proceeds to step S506.

In step S506, the processor 13 transfers the read data to a server requesting the read. Thereafter, the processing proceeds to step S507.

In step S507, the processor 13 sends a Good response to the server or a completion response to the caller, and ends the processing.

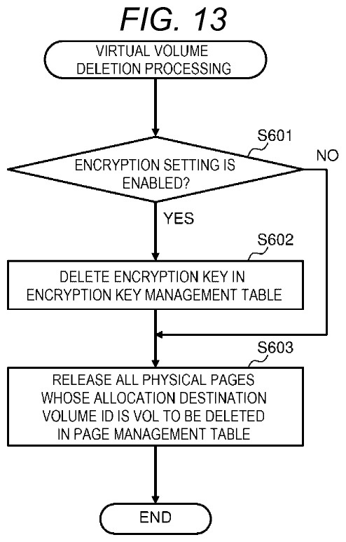

FIG. 13 is a flowchart illustrating a processing procedure of the virtual volume deletion processing 152. When the processor 13 reads and executes the virtual volume deletion processing 152 of the memory 14, the following steps S601 to S603 are sequentially executed.

In step S601, the processor 13 refers to the volume management table 141 and determines whether an encryption setting of a virtual volume to be deleted is enabled. If enabled (step S602: YES), the processing proceeds to step S602. If disabled (step S602: NO), the processing proceeds to step S603.

In step S602, the processor 13 deletes the encryption key in the encryption key management table 144. Thereafter, the processing proceeds to step S603.

In step S603, the processor 13 releases all the physical pages each of which the allocation destination volume ID is a volume to be deleted in the page management table 143, and ends the processing.

As described above, a system disclosed in the embodiment is the storage system 30 including the storage device 12; and the processor 13 configured to process data input to and output from the storage device, in which the processor 13 manages a correspondence relationship between an address in the pool volume 100 constructed in a storage area of the storage device and an address in a virtual volume provided to an outside by the logical-to-physical translation table 142, encrypts data with an encryption key and is configured to store the data in the pool volume 100 as encrypted data, when a plurality of pieces of the encrypted data of the same content encrypted with the same encryption key are present in the pool volume 100, executes the deduplication by leaving any of the encrypted data and releasing other encrypted data and associating an address of a virtual volume corresponding to the released encrypted data with the remaining encrypted data, and when unencrypted data having same content as the encrypted data is present in the pool volume 100, executes deduplication by releasing the encrypted data while leaving the unencrypted data, and associating an address of a virtual volume corresponding to the released encrypted data with the unencrypted data.

According to this configuration and operation, it is possible to reduce the number of keys that need to be managed in the storage system and achieve both the encryption and the deduplication while suppressing performance degradation.

Further, when a plurality of pieces of the encrypted data of the same content encrypted with different encryption keys are present in the pool volume, the processor 13 does not execute the deduplication

According to this configuration and operation, different users who use different encryption keys can individually store the encrypted data of the same content.

Further, the processor 13 is configured to construct a plurality of the virtual volumes, and set whether to execute the deduplication between the encrypted data and the unencrypted data for the virtual volumes.

According to this configuration and operation, it is possible to select whether to perform the deduplication according to a desire of the user when duplication with the unencrypted data is present.

Further, the processor 13 outputs a list of information related to the encrypted data subjected to the deduplication with the unencrypted data.

According to this configuration and operation, the user can confirm the effect of performing the deduplication between the encrypted data and the unencrypted data.

Further, the processor 13 generates the encryption key for each user and allocates the virtual volume for the user.

The virtual volume allocated to the user is a virtual volume that stores the encrypted data encrypted by a corresponding encryption key, and the processor 13 separately constructs a virtual volume that stores only the unencrypted data.

According to this configuration and operation, data can be efficiently managed by storing the encrypted data in the virtual volume for each user and storing the unencrypted data in the shared virtual volume.

Further, the processor 13 generates hash data regardless of whether the data is encrypted when a write request of the data is processed, and determines whether contents are the same by comparing the hash data.

Therefore, it is possible to efficiently determine whether the data has the same content.

The invention is not limited to the above-described embodiment and includes various modifications. The embodiment described above has been described in detail to facilitate understanding of the invention, and the invention is not necessarily limited to those including all the configurations described above. In addition, the configurations may not only be deleted, but also be replaced or added.

A part or all of the configurations, functions, processing units, processing methods, and the like described above may be implemented by hardware by, for example, designing with an integrated circuit. The invention can also be implemented by a program code of software for implementing functions of the embodiment. In this case, a recording medium recording the program code is provided to a computer, and a processor provided in the computer reads the program code stored in the recording medium. In this case, the program code read from the recording medium implements the functions of the embodiment described above by itself, and the program code itself and the recording medium storing the program code implement the invention. Examples of the recording medium for supplying such a program code include a flexible disk, a CD-ROM, a DVD-ROM, a hard disk, a solid state drive (SSD), an optical disk, a magneto-optical disk, a CD-R, a magnetic tape, a non-volatile memory card, and a ROM.

Further, the program code for implementing the functions described in the present embodiment can be implemented in a wide range of programs or script languages such as Assembler, C/C++, Perl, Shell, PHP, and Java (registered trademark).

Control lines and information lines considered to be necessary for description are shown in the embodiment described above, and not all control lines and information lines in a product are necessarily shown. All the configurations may be connected.

What is claimed is:

1. A storage system comprising:
a storage device; and
a processor configured to process data input to and output from the storage device, wherein
the processor
manages a correspondence relationship between an address in a pool volume constructed in a storage area of the storage device and an address in a virtual volume provided to an outside by a logical-to-physical translation table,
encrypts data with an encryption key and is configured to store the data in the pool volume as encrypted data, and
when unencrypted data having same content as the encrypted data is present in the pool volume, executes deduplication by releasing the encrypted data while leaving the unencrypted data, and associating an address of a virtual volume corresponding to the released encrypted data with the unencrypted data.

2. The storage system according to claim 1, wherein,
when a plurality of pieces of the encrypted data of the same content encrypted with the same encryption key are present in the pool volume, the processor executes the deduplication by leaving any of the encrypted data and releasing other encrypted data and associating an address of a virtual volume corresponding to the released encrypted data with the remaining encrypted data.

3. The storage system according to claim 1, wherein
when a plurality of pieces of the encrypted data of the same content encrypted with different encryption keys are present in the pool volume, the processor does not execute the deduplication.

4. The storage system according to claim 1, wherein
the processor is configured to
construct a plurality of the virtual volumes, and
set whether to execute the deduplication between the encrypted data and the unencrypted data for the virtual volumes.

5. The storage system according to claim 1, wherein
the processor outputs a list of information related to the encrypted data subjected to the deduplication with the unencrypted data.

6. The storage system according to claim 1, wherein
the processor
generates the encryption key for each user, and
allocates the virtual volume for the user.

7. The storage system according to claim 6, wherein
the virtual volume allocated to the user is a virtual volume that stores the encrypted data encrypted by a corresponding encryption key, and
the processor separately constructs a virtual volume that stores only the unencrypted data.

8. The storage system according to claim 1, wherein
the processor
generates hash data regardless of whether the data is encrypted when a write request of the data is processed, and
determines whether contents are the same by comparing the hash data.

9. A data management method in a storage system including a storage device, and a processor configured to process data input to and output from the storage device, the data management method comprising:
by the processor,
managing a correspondence relationship between an address in a pool volume constructed in a storage area of the storage device and an address in a virtual volume provided to an outside by a logical-to-physical translation table;
encrypting data with an encryption key and storing the data in the pool volume as encrypted data; and
a step of, when unencrypted data having same content as the encrypted data is present in the pool volume, the processor executing deduplication by releasing the encrypted data while leaving the unencrypted data, and associating an address of a virtual volume corresponding to the released encrypted data with the unencrypted data.

10. The data management method according to claim 9, further comprising:
a step of, when a plurality of pieces of the encrypted data of the same content encrypted with the same encryption key are present in the pool volume, the processor executing the deduplication by leaving any of the encrypted data and releasing other encrypted data and associating an address of a virtual volume corresponding to the released encrypted data with the remaining encrypted data.

11. The data management method according to claim 9, further comprising:
a step of, when a plurality of pieces of the encrypted data of the same content encrypted with different encryption keys are present in the pool volume, the processor determining that the processor does not execute the deduplication.

12. The data management method according to claim 9, further comprising:
a step of the processor outputting a list of information related to the encrypted data subjected to the deduplication with the unencrypted data.

13. The data management method according to claim 9, further comprising:
a step of the processor generating the encryption key for each user and allocating the virtual volume for the user.

14. The data management method according to claim 13, wherein
the virtual volume allocated to the user is a virtual volume that stores the encrypted data encrypted by a corresponding encryption key, and
the data management method further comprises: a step of the processor separately constructing a virtual volume that stores only the unencrypted data.

15. The data management method according to claim 9, further comprising:
a step of the processor generating hash data regardless of whether the data is encrypted when a write request of the data is processed, and determining whether contents are the same by comparing the hash data.
